(19) United States
(12) Patent Application Publication
(10) Pub. No.: US 2023/0251886 A1
(43) Pub. Date: Aug. 10, 2023

(54) THREAT RESISTANT MULTI-COMPUTING ENVIRONMENT

(71) Applicant: KAZUAR ADVANCED TECHNOLOGIES LTD., Tel-Aviv (IL)

(72) Inventors: Daniel Mondy FINCHELSTEIN, Rishon Lezion (IL); Yuval Moshe PORAT, Tel Aviv-Yafo (IL); Yaacov FENSTER, Petach Tikvah (IL); Shlomi Raz MARCO, Alfei Menashe (IL)

(21) Appl. No.: 18/000,383

(22) PCT Filed: Jun. 3, 2021
(86) PCT No.: PCT/IL2021/050665

§ 371 Date: Nov. 30, 2022

(30) Foreign Application Priority Data
Jun. 3, 2020 (IL) 275098

(51) Int. Cl. G06F 9/455

(52) U.S. Cl. CPC G06F 9/45558; G06F 2009/45595; G06F 2009/45587

(57) ABSTRACT

A computing system comprising: one or more processors configured to execute one or more computing environments (CEs) to access shared resources; a processor-based computing environment inspector unit (CEIU) operably connected to the one or more CEs and configured to inspect data generated by the one or more CEs; a processor-based mitigator unit (MET); and a storage medium; wherein the CEIU is further configured, responsive to detecting CE-generated data that is indicative of a compromise of a first CE, to notify the MU of the compromise of the first CE, and wherein the MU is configured, responsive to receiving notification of a compromise of the first CE, to disable access to the shared resources by the first CE.

### TECHNICAL FIELD

The presently disclosed subject matter relates to securing computing systems, and in particular to mitigating malware intrusions.

### BACKGROUND

Problems of malware infection and mitigation have been recognized in the conventional art and various techniques have been developed to provide solutions.

### GENERAL DESCRIPTION

According to one aspect of the presently disclosed subject matter there is provided a computing system, the system comprising:
one or more processors, the one or more processors configured to execute one or more computing environments (CEs), the one or more CEs being configured to access shared resources;
a processor-based computing environment inspector unit (CEIU) operably connected to the one or more CEs and configured to inspect data generated by the one or more CEs;
   a processor-based mitigator unit (MU); and
   a storage medium;
   wherein the CEIU is further configured, responsive to detecting CE-generated data that is indicative of a compromise of a first CE, to notify the MU of the compromise of the first CE,
   and wherein the MU is configured, responsive to receiving notification of a compromise of the first CE, to:
      disable access to the shared resources by the first CE.

In addition to the above features, the system according to this aspect of the presently disclosed subject matter can comprise one or more of features (i) to (x) listed below, in any desired combination or permutation which is technically possible:
(i) at least one of the one or more CEs is a guest CE, and wherein the MU has hypervisor capabilities
(ii) at least one of the one or more CEs is a base CE, and wherein the MU has boot loader capabilities.
(iii) the disabling access to shared resources comprises terminating the first CE.
(iv) the disabling access to shared resources comprises directing data generated by the first CE to a processor-based decoy resources unit, thereby isolating the first CE.
(v) the decoy resources unit is configured to store data derivative of received data that was generated by the first CE to the storage medium.
(vi) the decoy resources unit is configured to provide decoy data to the first CE.
(vii) the MU is further configured to, responsive to receiving the notification indicative of the compromise of the first CE:
   store, to the storage medium, data derivative of an executing state of the first CE,
   thereby giving rise to a CE image usable for threat analysis.
(viii) the MU is further configured to, subsequent to the disabling access to shared resources:
restore CE operation from a first CE boot image stored on the storage medium.
(ix) the CEIU is collocated in a network interface controller, and the CEIU is configured to inspect network data from the one or more CEs.
(x) the CEIU is a guest CE operably connected to a virtual network, and the CEIU is configured to inspect network data generated by the one or more CEs.

According to another aspect of the presently disclosed subject matter there is provided a method of mitigating compromise of computing environments (CEs) in a multiple CE system, the method comprising:
inspecting, by a processor-based computing environment inspector unit (CEIU), data generated by one or more CEs that are configured to access shared resources;
detecting, by the processor-based CEIU, CE-generated data that is indicative of a compromise of a first CE;
responsive to detecting the data indicative of compromise, notifying, by the processor-based CEIU, a processor-based mitigation unit (MU) of the compromise of the first CE;
responsive to receiving notification of a compromise of the first CE, disabling, by the MU, access of the shared resources by the first CE.

This aspect of the disclosed subject matter can optionally comprise one or more of features (i) to (x) listed above with respect to the system, mutatis mutandis, in any desired combination or permutation which is technically possible.

According to another aspect of the presently disclosed subject matter there is provided a computer program product comprising a computer readable storage medium containing program instructions, which program instructions when read by a processor, cause the processor to perform a method of mitigating compromise of computing environments (CEs) in a multiple CE system, the method comprising:
inspecting, by a processor-based computing environment inspector unit (CEIU), data generated by one or more CEs that are configured to access shared resources;
detecting, by the processor-based CEIU, CE-generated data that is indicative of a compromise of a first CE;
responsive to detecting the data indicative of compromise, notifying, by the processor-based CEIU, a processor-based mitigation unit (MU) of the compromise of the first CE;
responsive to receiving notification of a compromise of the first CE, disabling, by the MU, access of the shared resources by the first CE.

This aspect of the disclosed subject matter can optionally comprise one or more of features (i) to (x) listed above with respect to the system, mutatis mutandis, in any desired combination or permutation which is technically possible.

According to yet another aspect of the presently disclosed subject matter there is provided a computing system, the system comprising:
one or more processors, the one or more processors configured to execute one or more computing environments (CEs), the one or more CEs being configured to access shared resources;
a processor-based computing environment inspector unit (CEIU) operably connected to the one or more CEs and configured to inspect CE data of the one or more CEs,
a processor-based mitigator unit (MU);
wherein the CEIU is further configured, responsive to detecting CE data that is indicative of a compromise of a first CE, to notify the MU of the compromise of the first CE,
   and wherein the MU is configured, responsive to receiving notification of a compromise of the first CE, to perform at least one of a group comprising:
      a) disabling access to the shared resources by the first CE,
      b) storing data derivative of an executing state of the first CE, thereby giving rise to a CE image usable for threat analysis, and
      c) terminating the first CE and restoring CE operation from a first boot image of the first CE.

In addition to the above features, the system according to this aspect of the presently disclosed subject matter can comprise one or more of features (i) to (ix) listed below, in any desired combination or permutation which is technically possible:
(i) at least one of the one or more CEs is a guest CE, and the MU has hypervisor capabilities
(ii) at least one of the one or more CEs is a base CE, and the MU has boot loader capabilities
(iii) at least one of the one or more CEs is an operating system process
(iv) at least one of the one or more CEs is a container
(v) at least one of the one or more processors is in a remote device comprising a wireless link, a remote CE executes on the at least one processor, and the operable connection of the remote CE to the CEIU utilizes the wireless link
(vi) the MU is configured to disable access to shared resources by directing CE data of the first CE to decoy resources, thereby isolating the first CE
(vii) the decoy resources are configured to store data derivative of CE data of the first CE to a storage medium
(viii) the decoy resources are configured to provide decoy data to the first CE.the CEIU is collocated in a network interface controller, and the CEIU is configured to inspect network data from the one or more CEs
(ix) the CEIU is a guest CE operably connected to a virtual network, and the CEIU is configured to inspect at least one of: network data generated by one or more of the CEs, and network data transmitted to one or more of the CEs

According to another aspect of the presently disclosed subject matter there is provided a method of mitigating compromise of computing environments (CEs), the method comprising:
inspecting, by a processor-based computing environment inspector unit (CEIU), CE data of one or more CEs that are configured to access shared resources;
detecting, by the processor-based CEIU, CE data that is indicative of a compromise of a first CE;
responsive to detecting the data indicative of compromise, notifying, by the processor-based CEIU, a processor-based mitigation unit (MU) of the compromise of the first CE; and
responsive to receiving notification of a compromise of the first CE, performing, by the MU, at least one of a group comprising:
a) disabling access to the shared resources by the first CE,
b) storing data derivative of an executing state of the first CE, thereby giving rise to a CE image usable for threat analysis, and
c) terminating the first CE and restoring CE operation from a first boot image of the first CE.

This aspect of the disclosed subject matter can optionally comprise one or more of features (i) to (ix) listed above with respect to the system, mutatis mutandis, in any desired combination or permutation which is technically possible.

According to another aspect of the presently disclosed subject matter there is provided a computer program product comprising a computer readable storage medium containing program instructions, which program instructions when read by a processor, cause the processor to perform a method of mitigating compromise of computing environments (CEs), the method comprising:
inspecting, by a processor-based computing environment inspector unit (CEIU), CE data of one or more CEs that are configured to access shared resources;
detecting, by the processor-based CEIU, CE data that is indicative of a compromise of a first CE;
responsive to detecting the data indicative of compromise, notifying, by the processor-based CEIU, a processor-based mitigation unit (MU) of the compromise of the first CE; and
responsive to receiving notification of a compromise of the first CE, performing, by the MU, at least one of a group comprising:
d) disabling access to the shared resources by the first CE,
e) storing data derivative of an executing state of the first CE, thereby giving rise to a CE image usable for threat analysis, and
f) terminating the first CE and restoring CE operation from a first boot image of the first CE.

This aspect of the disclosed subject matter can optionally comprise one or more of features (i) to (ix) listed above with respect to the system, mutatis mutandis, in any desired combination or permutation which is technically possible.

Among advantages of certain embodiments of the presently disclosed subject matter is heightened resilience against compromise of computing environments by malware.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1A illustrates a block diagram of an example threat-resistant multi-computing environment system, according to some embodiments of the presently disclosed subject matter;

FIG. 1B illustrates a block diagram of an example variation of a threat-resistant multi-computing environment system, according to some embodiments of the presently disclosed subject matter;

FIG. 2 illustrates a flow diagram of an example process of mitigating a potentially compromised computing environment in a threat-resistant multi-computing environment system, according to some embodiments of the presently disclosed subject matter; and

FIG. 3 illustrates a flow diagram of an example process of data flow of a compromised computing environment for which hypervisor isolation has been configured, according to some embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “comparing”, “notifying”, “inspecting”, “determining”, “calculating”, “receiving”, “mitigating”, “halting”, “isolating”, “providing”, “restoring” or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the processor, mitigation unit, and inspection unit therein disclosed in the present application.

The terms “non-transitory memory” and “non-transitory storage medium” used herein should be expansively construed to cover any volatile or non-volatile computer memory suitable to the presently disclosed subject matter.

The operations in accordance with the teachings herein may be performed by a computer specially constructed for the desired purposes or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages may be used to implement the teachings of the presently disclosed subject matter as described herein.

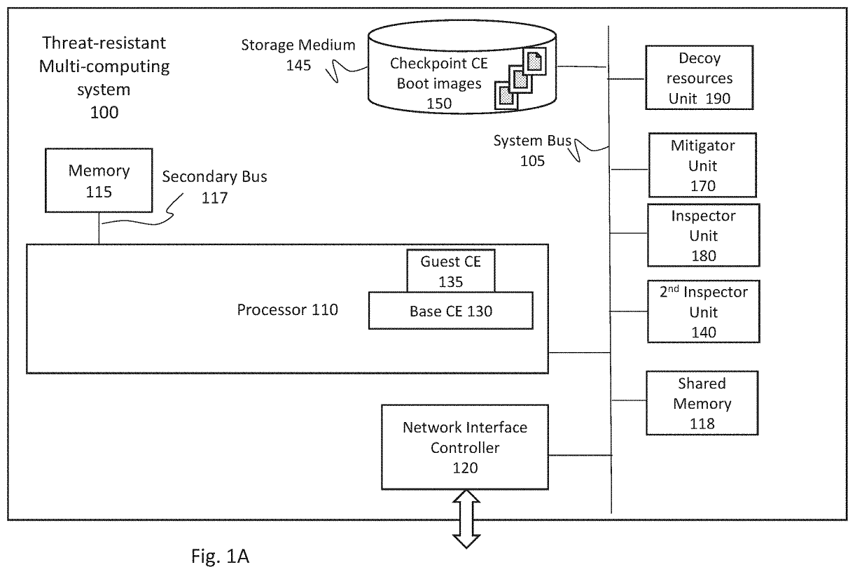

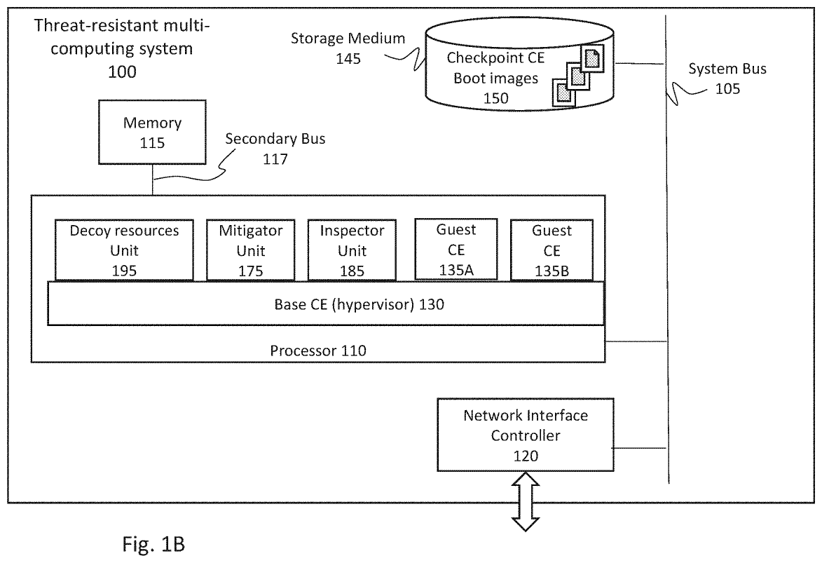

Bearing this in mind, attention is now directed to FIG. 1A, which illustrates a block diagram of an example threat-resistant multi-computing environment system, according to some embodiments of the presently disclosed subject matter.

Despite widespread deployment of diverse security mechanisms, there exist numerous threat vectors which enable cyber attacks against networked computing devices. These vectors include email, web content, Universal Serial Bus (USB) devices, rogue mobile apps etc. These methods of system access constitute entry points for launching attacks against or stealing information from an organization or from individuals.

Notwithstanding efforts to habituate users to avoid social engineering attacks and deployment of anti-malware solutions, organizations and individuals are still falling victim to attacks. In some cases, malware instances become resident on certain computer components (e.g. low-level operating systems software) outside the scope of conventional anti-malware protection. In some cases, malware instances have mechanisms that enable them to escape detection by conventional anti-malware mechanisms.

In some embodiments, the present subject matter describes a threat-resistant multi-computing system 100 which can include multiple computing environments (CEs)—together with an infrastructure for monitoring CEs and detecting/mitigating any compromises.

Incubation time for “adversary tool” malware can be—for example—14 days. Frequently: an adversary can passively monitor system activity for—for example—50-150 days. Consequently restoring CEs daily or weekly can constitute successful mitigation of the activity of such types of adversaries.

For clarity in description of the presently disclosed subject matter, FIG. 1A illustrates an example threat-resistant computing system 100 including a single processor 110 with a single memory 115 operably connected via a secondary bus 117. It is noted that in some embodiments threat-resistant multi computing system 100 can include one or more processors, and these can be operably interconnected with one or more memories and other components in various manners, as known in the art. It is further noted that descriptions below pertaining to processor 110 can apply equally to additional processors (in embodiments where such processors are present).

Threat-resistant computing system 100 can include a processor 110. Processor 110 can be a suitable hardware-based electronic device with data processing capabilities, such as, for example, a general purpose processor, a specialized Application Specific Integrated Circuit (ASIC), one or more cores in a multicore processor etc. Processor 110 can also consist, for example, of multiple processors, multiple ASICs, virtual processors, combinations thereof etc. Processor 110 can be operably connected to system bus 105.

A memory 115 can be, for example, a suitable kind of volatile or non-volatile storage, and can include, for example, a single physical memory component or a plurality of physical memory components. Memory 115 can also include virtual memory. Memory 115 can be configured to, for example, store various data used in computation.

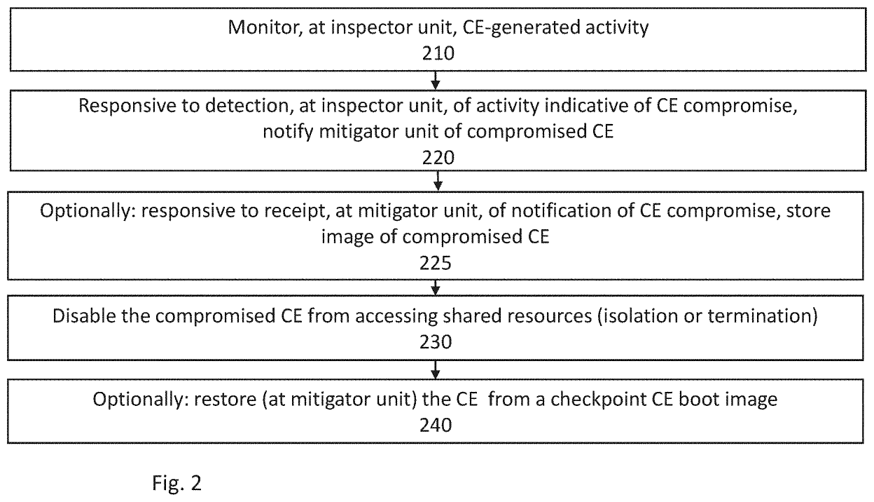

As will be further detailed hereinbelow with reference to FIG. 2, processor 110 can be configured to execute several functional modules in accordance with computer-readable instructions implemented on a non-transitory computer-readable storage medium. Such functional modules are referred to hereinafter as comprised in the processor. These modules can include, for example, computing environments (CEs) as will be described below.

In the present disclosure, the term “computing environment” (CE) includes, by way of non-limiting example, a software module (e.g. executing on a processor such as a physical processor or virtual processor) which a processor (such as a boot processor executing a BIOS or a general-purpose processor executing a hypervisor) can initialize from a boot image.

By way of non-limiting example: a computing environment can be a general purpose software operating system such as Linux, Microsoft Windows™, a special-purpose realtime operating system such as embedded Linux, a dedicated user application etc. The term “Base CE” includes a CE executing on a physical processor in the absence of a hypervisor or other virtualization/guesting technology. In some embodiments a Base CE provides hypervisor or other virtualization/guesting functionality.

In some embodiments, a Base CE can include for example, hypervisor technologies such as Linux Kernel-based Virtual Machine or Microsoft Windows Hyper-V. In such embodiments, additional CEs can execute in virtual machines (VMs) enabled by such Base CEs. The term “guest CE” includes a CE executing on a processor (physical or virtual) which is enabled by a hypervisor or other virtualization/guesting technology in a Base CE. A guest CE can execute, for example, a general purpose software operating system such as Linux, Microsoft Windows™, a special-purpose realtime operating system such as embedded Linux, a dedicated user application etc.

In some embodiments, Guest CEs can be implemented using other technologies that support initialization from CE boot images (e.g. a suitable container technology, executable process, chroot etc.)

In FIG. 1A, Base CE (including Hypervisor) 130 is executing on processor 110 and comprised in processor 110. Guest CE 135A 135B is, by way of non-limiting example, a VM running on Base CE (including Hypervisor) 130, and is also comprised in processor 110.

In some embodiments, A guest CEs can be located on remote devices (e.g. internet-of-things devices) which are operably connected to inspector unit 180 via a wireless communication link such as wifi or Bluetooth.

In some embodiments, threat-resistant computing system 100 can include a boot processor (not shown) that can execute a CE (e.g. a basic input/output system i.e. BIOS) which performs basic functions for initializing CEs on processor 110.

Network Interface Controller 120 can be a suitable type of network interface such as ethernet, Institute of Electrical and Electronics Engineers (IEEE) 802.11 etc. and can be operably connected to system bus 105. Processor 110 and comprised CEs 130 135A 135B can, for example, send and receive data to/from external entities via network interface controller 120.

Storage media 145 can be a suitable type of storage (e.g. non-volatile storage such as disk-based or flash-based storage systems etc.) as known in the art, and can be operably connected to system bus 105.

In some embodiments, storage media 145 can store checkpoint CE boot images 150. In some embodiments, checkpoint CE boot images 150 are boot images that were created from executing CEs. An embodiment-specific component (e.g. mitigator unit 170, or a CE itself, or a dedicated image creation unit (not shown)) can periodically (or upon occurrence of an event) create a checkpoint CE boot image 150 from a CE that has been determined or assessed to be a computing environment uncompromised by malware.

In some embodiments, checkpoint CE boot images can be subsequently utilized for restoring a CE following an assessment of possible compromise by malware, as will be described below with reference to FIG. 2.

In some embodiments, storage media 145 can store images of compromised CEs for analysis.

Threat-resistant multi-computing system 100 can include resources that are shared among CEs. For example, Guest CE 135A 135B and base CE 130 can share access of utilization of Network Interface Controller 120, Shared Memory 118, or other suitable components. Accordingly, the CEs 130 135A 135B can be configured to access these shared resources.

Inspector unit 180 (also termed CE inspector unit) can be operably connected to system bus 105 and can communicate with other operably connected system components via system bus 105 using—for example—methods as known in the art. Inspector Unit 180 can be a dedicated processor (such as a general purpose processor executing software). Alternatively, Inspector Unit 180 can be an ASIC, or another kind of device with processing capability such as the implementations described above regarding processor 110.

Inspector unit 180 can be configured to inspect—for example—system bus 105 for CE-generated or CE-addressed bus activity that is indicative of the computing environment (CE) (for example: a guest CE or base CE) having been compromised by malware or compromised in another manner. By way of non-limiting example, the inspector can detect that the statistical distribution of bus requests by a CE deviates from a monitored or configured norm. By way of further non-limiting example, the inspector can detect that CPU usage, access of hardware drivers, or system calls deviate from a monitored or configured norm.

Responsive to detecting compromise of a CE, Inspector unit 180 can be configured to notify mitigator unit 170 that the CE has been compromised. By way of non-limiting example, inspector unit 180 can write a secured (e.g. authenticated) message to a shared memory 118 location that is read by mitigator unit 170. By way of non-limiting example, such a message can include data indicative of a system bus 105 address indicative of the processor which is executing the potentially compromised CE.

In some embodiments, inspector unit 180 can be colocated with other components such as—for example—mitigator unit 170. In some embodiments, inspector unit 180 can itself be a CE.

In some embodiments, inspector unit 180 can be colocated with network interface controller 120. In some such embodiments, inspector unit 180 can read data sent by other components (such as processor 110) for transmission over the NIC and inspect such data and/or metadata (such as identity of the transmitter and receiver, packet length etc.). In some such embodiments, inspector unit 180 can read data received over a communications medium and inspect such data and/or metadata. In some such embodiments, inspector unit 180 can inspect the CE-generated network traffic data (as well as data destined to the CE) for data indicative of compromise of the CE. The term “CE data” is used herein to refer to data that is generated by a particular CE or is destined to the particular CE.

Mitigator unit 170 can be operably connected to system bus 105 and communicate with other operably connected system components using—for example—methods as known in the art. Mitigator unit 170 can be a dedicated processor (such as a general purpose processor executing software). Alternatively, mitigator unit 170 can be an ASIC, or another kind of device with processing capability such as the implementations described above regarding processor 110. In some embodiments, mitigator unit 170 can be colocated with other components such as—for example—inspector unit 180. In some embodiments, mitigator unit 170 can itself be a CE.

Mitigator unit 170 can be configured, responsive to a notification of possible compromise of a CE, to mitigate the compromise by disabling the CE from access of shared resources of threat-resistant multi-computing system 100. In some embodiments, mitigator unit 170 disables CE access to shared resources by terminating the execution of the CE (optionally, the MU can then restore CE operation from a check point boot image). In some embodiments, mitigator unit 170 disables CE access to shared resources by isolating the CE (as described hereinbelow).

In some embodiments, mitigator unit 170 can, responsive to a notification of a potential security compromise of a CE on a processor, store data derivative of an executing state of the potentially compromised CE (e.g. an image of the CE including, code, stack, etc.) to storage medium 145. The stored image of the potentially compromised CE can then be accessed later for analysis.

In some embodiments, mitigator unit 170 can, in tandem, or subsequent to, halting the execution of the potentially compromised CE, restore the CE by triggering a process to begin executing a particular previously stored checkpoint CE boot image. In some embodiments, mitigator unit 170 can set parameters (e.g. network interface addresses, memory configurations, or other parameters) of a restored CE to different values or randomized values. Modifying the parameters in this manner can be disruptive to malware, or to its gathering of information.

In some embodiments, mitigator unit 170 can utilize a mitigation policy to determine the mitigation action(s) to apply to a the potentially compromised CE. In some embodiments, the mitigation policy can be static e,g, hardcoded in software. In some embodiments, the mitigation policy can be dynamic e.g. the types of mitigations executed can depend on—for example the frequency of detections of potentially compromised CEs.

Mitigator unit 170 can be configured with boot loader capabilities to enable it to halt and restore a Base CE 130. For example, mitigator unit 170 can implement boot loader capabilities (e.g. support methods for initiating/terminating computing environments using methods appropriate to the particular implementation as known in the art). Alternatively, mitigator unit 170 can control a boot loader located elsewhere in threat-resistant multi-computing system 100.

Mitigator unit 170 can be configured with hypervisor capabilities to enable it to halt and restore a guest CE 135A 135B as described hereinbelow.

Mitigator unit 170 can enable isolation of the potentially compromised base CE 130 using, for example, methods appropriate to the particular type of bus or network to which Base CE 130 is operably connected. For example: mitigator unit 170 can configure functions of system bus 105 so that data generated by the potentially compromised CE is directed to decoy resources unit 195. Decoy resources unit 195 can store data indicative of data received from the potentially compromised CE to storage medium 145. Decoy resources unit 190 can provide decoy data to the potentially compromised CE as described hereinbelow.

Decoy resources unit 195 can be, for example, operably connected to system bus 105 and communicate with other operably connected system components using—for example—methods as known in the art. Such a decoy resources unit can be a dedicated processor (such as a general purpose processor executing software) or an ASIC, or another kind of device with processing capability such as the implementations described above regarding processor 110.

Decoy resources unit 195 can be utilized as part of isolation of a potentially compromised CE. Specifically: during isolation, decoy resources unit 195 can be configured to receive data from a potentially compromised CE. In some embodiments, decoy resources unit 195 analyzes the data received from the potentially compromised CE so as to determine what type of malware may have affected the CE etc. In some embodiments, decoy resources unit 195 stores (for example; to storage medium 145) data derivative of data received from the potentially compromised CE for subsequent analysis (e.g. offline analysis). In some embodiments, decoy resources unit 195 provides decoy data (e.g. data that resembles data that would be provided to the CE) to the potentially compromised CE. In this manner, the threat-resistant multi-computing system 100 can monitor behavior of a compromised CE without threatening the integrity of threat-resistant multi-computing system 100.

2nd inspector unit 140 can be a dedicated processor (such as a general purpose processor executing software). Alternatively, 2nd inspector unit 140 can be an ASIC, or another kind of device with processing capability such as the implementations described above regarding processor 110. In some embodiments, 2nd inspector unit 140 can be a CE.

2nd inspector unit 140 can be operably connected to system bus 105 and can read and inspect bus signals of system bus 105. 2nd inspector unit 140 can be configured to perform inspection on—for example—bus signals to/from inspector unit 180, and inspect these of indications that inspector unit 180 has been comprised by malware or in a different manner. 2nd inspector unit 140 can be configured to notify mitigator unit 170 of a potential compromise of inspector unit 180. Mitigator unit 170 can mitigate the potentially compromise of inspector unit 180, in the same manner as for CEs (as described herein).

It is noted that the teachings of the presently disclosed subject matter are not bound by the interactive instruction system and subject guidance systems described with reference to FIG. 1A. Equivalent and/or modified functionality can be consolidated or divided in another manner and can be implemented in any appropriate combination of software with firmware and/or hardware and executed on a suitable device. The interactive instruction system and subject guidance systems can each be a standalone entity, or integrated, fully or partly, with other entities—via a network or other means.

Attention is now directed to FIG. 1B, which illustrates a block diagram of an example variation of a threat-resistant multi-computing system, according to some embodiments of the presently disclosed subject matter.

In the threat-resistant multi-computing system 100 illustrated in FIG. 1B, inspector unit 185 can be comprised in processor 110. In particular, inspector unit 185 can be, for example, a guest CE (e.g. virtual machine) enabled by the hypervisor function of base CE (hypervisor) 130.

In some embodiments, guest CEs 135A 135B can communicate among each other via a virtual network interface (not shown) that is internal to the base CE (hypervisor) 130. In some such embodiments, inspector unit 185 can be operably connected to the virtual network interface and receive network data transmitted by/destined for user CEs 135A 135B, and inspect the data and/or the metadata (such as identity of the transmitter and receiver, packet length etc.). In other embodiments guest CEs 135A 135B and/or inspector unit 185 can communicate using other suitable mechanism(s). In some embodiments, guest CEs 135A 135B and inspector unit 185 can communicate with components (e.g. network interface controller 120) that are operably connected to system bus 105 via Base CE (hypervisor) 130. Inspector unit 185 of FIG. 2 can inspect—for example—the same behaviors of a CE and CE data as described above with reference to inspector unit 180 of FIG. 1.

It is noted that FIG. 1B illustrates a particular non-limiting example configuration of guest CEs and Base CEs. In other examples, guest CEs may be located within containers, processes etc. and communicate with other system components with suitable mechanisms as known in the art.

In the threat-resistant multi-computing system 100 illustrated in FIG. 1B, mitigator unit 175 can be comprised in processor 110. In some embodiments, mitigator unit 175 can be a CE with capability to manage the hypervisor functions of base CE (hypervisor) 130. In some other embodiments, mitigator unit 175 can be integrated with the hypervisor functions of base CE (hypervisor) 130 (for example as an integrated software module comprised entirely inside a hypervisor module in base CE (hypervisor) 130).

The term “hypervisor capabilities” as used herein includes the capability of halting and/or restoring a CE from boot image, as well as the capabilities for transferring data between CEs as well as modifying and redirecting data being transferred between CEs and other functions utilized in hypervisor isolation of a CE as described hereinbelow. In some embodiments, mitigator unit 175 has hypervisor capabilities—for example: by integration with a hypervisor or by management of a hypervisor.

In some embodiments, responsive to receiving a notification from inspector unit 185 of potential compromise of a guest CE 135A 135B, mitigator unit 175 can utilize hypervisor capabilities to halt a compromised guest CE 135A 135B.

In some embodiments, mitigator unit 175 can concurrently (e.g. responsive to receiving a notification from inspector unit 185 of potential compromise of a guest CE 135A 135B) or subsequently restore the guest CE 135A 135B from an appropriate checkpoint CE boot image 150.

In some embodiments, responsive to receiving a notification from inspector unit 185 of potential compromise of a guest CE 135A 135B, mitigator unit 175 can store data derivative of an executing state of a potentially compromised guest CE 135A 135B (e.g. an image or “snapshot”) to storage medium 145. The image can then be subject to e.g. offline analysis.

In some embodiments, mitigator unit 175 can, upon receiving a notification of a potential security compromise of a guest CE 135A 135B, configure hypervisor isolation of the potentially compromised CE. In some embodiments, when hypervisor isolation is configured for a CE, the CE continues to execute, but does not directly access some or all of the shared resources in threat-resistant multi-computing system 100.

Mitigator unit 170 can enable hypervisor isolation of the potentially compromised guest CE 135A 135B using, for example, methods appropriate to the particular type of hypervisor in Base CE 130. For example: mitigator unit 170 can configure hypervisor functions of base CE (hypervisor) 130 so that data generated by the potentially compromised CE is directed to decoy resources unit 195. Decoy resources unit 195 can store data indicative of data received from the potentially compromised CE to storage medium 145. Decoy resources unit 190 can provide decoy data to the potentially compromised CE as described hereinbelow.

Decoy resources unit 195 can be, for example, a guest CE (e.g. virtual machine) enabled by the hypervisor function of base CE (hypervisor) 130. Alternatively, a decoy resources unit can be—for example—operably connected to system bus 105 and communicate with other operably connected system components using—for example—methods as known in the art. Such a decoy resources unit can be a dedicated processor (such as a general purpose processor executing software) or an ASIC, or another kind of device with processing capability such as the implementations described above regarding processor 110.

Decoy resources unit 195 can be utilized as part of a hypervisor isolation of a potentially compromised CE. Specifically: during hypervisor isolation, decoy resources unit 195 can be configured to receive data from a potentially compromised CE. In some embodiments, decoy resources unit 195 analyzes the data received from the potentially compromised CE so as to determine what type of malware may have affected the CE etc. In some embodiments, decoy resources unit 195 stores (for example; to storage medium 145) data derivative of data received from the potentially compromised CE for subsequent analysis (e.g. offline analysis). In some embodiments, decoy resources unit 195 provides decoy data (e.g. data that resembles data that would be provided to the CE) to the potentially compromised CE. In this manner, the threat-resistant multi-computing system 100 can monitor behavior of a compromised CE without threatening the integrity of threat-resistant multi-computing system 100.

It is noted that the teachings of the presently disclosed subject matter are not bound by the interactive instruction system and subject guidance systems described with reference to FIG. 1B. Equivalent and/or modified functionality can be consolidated or divided in another manner and can be implemented in any appropriate combination of software with firmware and/or hardware and executed on a suitable device. The interactive instruction system and subject guidance systems can each be a standalone entity, or integrated, fully or partly, with other entities—via a network or other means.

Attention is now directed to FIG. 2, which illustrates a flow diagram of an example process of mitigating a potentially compromised computing environment of a threat-resistant multi-computing environment system, according to some embodiments of the presently disclosed subject matter.

An inspector unit 180 or 185 can monitor (210) CE-generated activity. For example: inspector unit 180 or 185 can monitor bus signals or network traffic from/to a processor 110 executing a CE (eg. Base CE (hypervisor) 130 or user CE 135A 135B)—as described hereinabove) and thereby inspect the data that is generated or received by by the CE. In some embodiments, an inspector unit 180 (for example: implemented as software running on a processor) monitors bus activity or network traffic—as described hereinabove with reference to FIG. 1A. In some embodiments, an inspector unit 185 is implemented as a guest CE (e.g. virtual machine) and monitors e.g. network traffic over a virtual network as described above with reference to FIG. 1B.

Responsive to detection of CE-generated activity indicative of CE compromise or potential CE compromise, inspector unit 180 or 185 can notify (220) mitigator unit 170 or 175 regarding the compromised CE. For example: inspector unit 180 or 185 can send a message of notification to mitigator unit 170 or 175 via an embodiment-appropriate notification mechanism (e.g. secure messaging).

Optionally: Responsive to mitigator unit 170 or 175 being notified of a CE compromise, mitigator unit 170 or 175 can store (225) data derivative of an image of potentially compromised guest CE 135A 135B (e.g. the image or “snapshot” as described hereinabove) to storage medium 145. The image can then be subject to e.g. offline analysis.

Responsive to mitigator unit 170 or 175 being notified of a CE compromise, mitigator unit 170 or 175 can disable (230) access to some or all shared resources by the compromised CE.

In some embodiments, mitigator unit 170 or 175 can disable access to shared resources by terminating the compromised CE. By way of non-limiting example, mitigator unit 170 can utilize boot loader capability as described above with reference to FIG. 1A to terminate a compromised base CE 130. By way of further non-limiting example, mitigator unit 175, can utilize hypervisor capabilities as described above with reference to FIG. 1B, to terminate a compromised guest CE 135A 135B.

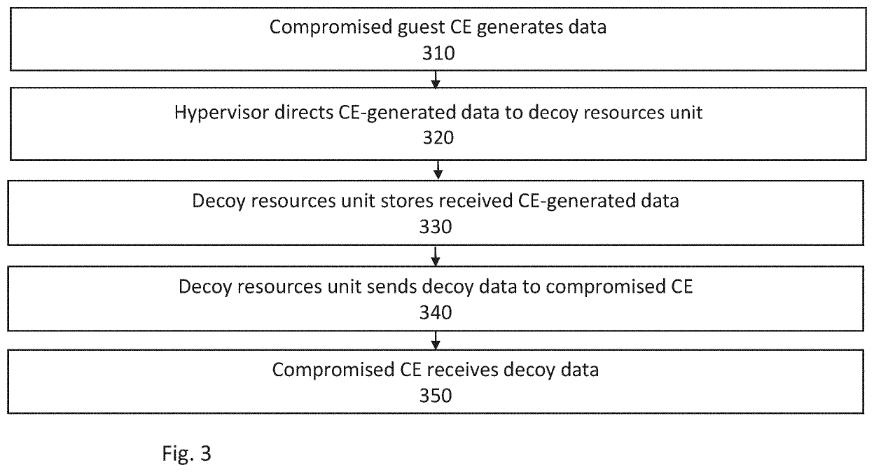

In some embodiments, mitigator unit 170 or 175 can disable access to shared resources by configuring hypervisor isolation of a compromised guest CE 135A 135B. By way of non-limiting example, mitigator unit 175, can utilize hypervisor capabilities as described above with reference to FIG. 1B, to configure hypervisor isolation of a compromised guest CE 135A 135B. Hypervisor isolation is described in further detail below with reference to FIG. 3.

Optionally: in tandem or subsequent to terminating a compromised CE, mitigator unit 170 or 175 can restore (240) the CE e.g. from a checkpoint CE boot image 240. By way of non-limiting example, mitigator unit 170 can utilize boot loader capabilities as described above with reference to FIG. 1A to restore a Base (hypervisor) CE 130. By way of further non-limiting example, mitigator unit 175 can utilize hypervisor capabilities as described above with reference to FIG. 1B to restore a guest CE 135A 135B.

In some embodiments, mitigator unit 170 can set parameters (e.g. network interface addresses, memory configurations, or other parameters) of a restored CE to different values or randomized values. Modifying the parameters in this manner can be disruptive to malware, or to its gathering of information.

In some embodiments, mitigator unit 170 can utilize a mitigation policy to determine the mitigation action(s) to apply to a the potentially compromised CE. In some embodiments, the mitigation policy can be static e,g, hardcoded in software. In some embodiments, the mitigation policy can be it can be dynamic e.g. the types of mitigations executed can depend on—for example the frequency of detections of potentially compromised CEs.

It is noted that the teachings of the presently disclosed subject matter are not bound by the flow diagram illustrated in FIG. 2, the illustrated operations can occur out of the illustrated order. For example, operations 225 and 230 shown in succession can be executed substantially concurrently. It is also noted that whilst the flow chart is described with reference to elements of the systems of FIGS. 1A and 1B, this is by no means binding, and the operations can be performed by elements other than those described herein.

Attention is now directed to FIG. 3, which illustrates a flow diagram of an example process of data flow from a compromised guest CE 135A 135B when hypervisor isolation is enabled, according to the some embodiments of the presently disclosed subject matter.

Compromised guest CE 135A 135B can generate (310) data. This data can include—for example—requests to read or write from memory or storage, particular execution paths, or to transmit network data. These generated data can be benign or malicious.

Since hypervisor isolation has been configured, the hypervisor (for example) can direct (320) CE-generated data to the decoy resources unit 195. In this manner, CE activity can be frozen, and in particular shared resources are not affected by CE data.

Decoy resources unit can store (330) received data that was generated by the compromised guest CE 135A 135B (for example: to storage medium 145) for security analysis.

Decoy resources unit 195 can send (340) decoy data to the compromised guest CE 135A 135B. Decoy data can be data that resembles the data that the compromised CE would receive in response to its requests. In this manner, threat-resistant multi-computing system 100 can continue to receive data generated by the compromised guest CE 135A 135B, thus facilitating threat analysis.

Compromised guest CE 135A 135B can receive (350) decoy data and continue to execute without negatively affecting threat-resistant multi-computing system 100 or sensitive shared resources.

It is noted that the teachings of the presently disclosed subject matter are not bound by the flow diagram illustrated in FIG. 3, the illustrated operations can occur out of the illustrated order. For example, operations 325 and 330 shown in succession can be executed substantially concurrently. It is also noted that whilst the flow chart is described with reference to elements of the systems of FIGS. 1A and 1B, this is by no means binding, and the operations can be performed by elements other than those described herein.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A computing system comprising:
one or more processors, the one or more processors configured to execute one or more computing environments (CEs), the one or more CEs being configured to access shared resources;
a processor-based computing environment inspector unit (CEIU) operably connected to the one or more CEs and configured to inspect CE data of the one or more CEs,
a processor-based mitigator unit (MU);
wherein the CEIU is further configured, responsive to detecting CE data that is indicative of a compromise of a first CE, to notify the MU of the compromise of the first CE,
and wherein the MU is configured, responsive to receiving notification of a compromise of the first CE, to perform at least one of a group comprising:
a) disabling access to the shared resources by the first CE,
b) storing data derivative of an executing state of the first CE, thereby giving rise to a CE image usable for threat analysis, and
c) terminating the first CE and restoring CE operation from a first boot image of the first CE.

2. The system of claim 1, wherein at least one of the one or more CEs is a guest CE, and wherein the MU has hypervisor capabilities.

3. The system of claim 1, wherein at least one of the one or more CEs is a base CE, and wherein the MU has boot loader capabilities.

4. The system of claim 1, wherein at least one of the one or more CEs is an operating system process.

5. The system of claim 1, wherein at least one of the one or more CEs is a container.

6. The system of claim 1, wherein
at least one of the one or more processors is in a remote device comprising a wireless link,
a remote CE executes on the at least one processor, and
the operable connection of the remote CE to the CEIU utilizes the wireless link.

7. The system of claim 1, wherein the MU is configured to disable access to shared resources by directing CE data of the first CE to decoy resources, thereby isolating the first CE.

8. The system of claim 7, wherein the decoy resources are configured to store data derivative of CE data of the first CE to a storage medium.

9. The system of claim 7, wherein the decoy resources are configured to provide decoy data to the first CE.

10. The system of claim 1, wherein the CEIU is collocated in a network interface controller, and wherein the CEIU is configured to inspect network data from the one or more CEs.

11. The system of claim 1, wherein the CEIU is a guest CE operably connected to a virtual network, and wherein the CEIU is configured to inspect at least one of:
network data generated by one or more of the CEs, and
network data transmitted to one or more of the CEs.

12. A method of mitigating compromise of computing environments (CEs), the method comprising:
inspecting, by a processor-based computing environment inspector unit (CEIU), CE data of one or more CEs that are configured to access shared resources;
detecting, by the processor-based CEIU, CE data that is indicative of a compromise of a first CE;
responsive to detecting the data indicative of compromise, notifying, by the processor-based CEIU, a processor-based mitigation unit (MU) of the compromise of the first CE; and
responsive to receiving notification of a compromise of the first CE, performing, by the MU, at least one of a group comprising:
g) disabling access to the shared resources by the first CE,
h) storing data derivative of an executing state of the first CE, thereby giving rise to a CE image usable for threat analysis, and
i) terminating the first CE and restoring CE operation from a first boot image of the first CE.

13. The method of claim 12, wherein the disabling access to shared resources comprises directing CE data of the first CE to a decoy resources unit, thereby isolating the first CE.

14. The method of claim 12, further comprising, subsequent to the disabling access to shared resources: restoring, by the processor-based MU, CE operation from a first CE boot image stored on a storage medium.

15. The method of claim 13, wherein the decoy resources provide decoy data to the first CE.

16. A computer program product comprising a computer readable storage medium containing program instructions, which program instructions when read by a processor, cause the processor to perform a method of mitigating compromise of computing environments (CEs), the method comprising:
inspecting, by a processor-based computing environment inspector unit (CEIU), CE data of one or more CEs that are configured to access shared resources;
detecting, by the processor-based CEIU, CE data that is indicative of a compromise of a first CE;
responsive to detecting the data indicative of compromise, notifying, by the processor-based CEIU, a processor-based mitigation unit (MU) of the compromise of the first CE; and
responsive to receiving notification of a compromise of the first CE, performing, by the MU, at least one of a group comprising:
j) disabling access to the shared resources by the first CE,
k) storing data derivative of an executing state of the first CE, thereby giving rise to a CE image usable for threat analysis, and
l) terminating the first CE and restoring CE operation from a first boot image of the first CE.

17. The computer program product of claim 16, wherein disabling access to shared resources comprises terminating the first CE.

18. The computer program product of claim 16, wherein disabling access to shared resources directing CE data of the first CE to a decoy resources unit, thereby isolating the first CE.

19. The computer program product of claim 16, wherein the method further comprises, subsequent to the disabling access to shared resources: restoring, by the processor-based MU, CE operation from a first CE boot image stored on a storage medium.
